(19) United States
(12) Patent Application Publication
(10) Pub. No.: US 2026/0239370 A1
(43) Pub. Date: Aug. 13, 2026

(54) TRANSMISSION CONFIGURATION INDICATOR TECHNIQUES USING A SECOND ACTION DELAY

(71) Applicant: Google LLC, Mountain View, CA (US)

(72) Inventors: Yushu ZHANG, Beijing (CN); Jia-Hong LIOU, Taipei City (CN)

(21) Appl. No.: 19/156,886

(22) PCT Filed: Sep. 8, 2023
(86) PCT No.: PCT/CN2023/117691

§ 371 Date: Aug. 14, 2025

(30) Foreign Application Priority Data
Feb. 17, 2023 (WO) PCT/CN2023/076948

(51) Int. Cl. H04W 72/231; H04B 7/06; H04L 5/00; H04W 72/51; H04W 76/20; H04W 84/06

(52) U.S. Cl. CPC H04W 72/231; H04B 7/06968; H04L 5/0053; H04W 72/51; H04W 76/20; H04W 84/06

(57) ABSTRACT

This disclosure provides systems, devices, apparatus, and methods, including computer programs encoded on storage media, for indicating transmission configuration indicator (TCI) states. A UE (102) receives (504), from a network entity, a radio resource control (RRC) signaling configuring a list of TCI states and a first action delay. The UE receives (510), from the network entity, a downlink control information (DCI) including a DCI based TCI indication indicating at least one TCI state from the list of TCI states. The UE transmits (512), to the network entity, an acknowledgement (ACK) for the DCI based TCI indication. The UE communicates (516), with the network entity, based on an action time associated with the at least one TCI state. The action time is based on at least a second action delay for the DCI based TCI indication.

### CROSS REFERENCE TO RELATED APPLICATION(S)

This application claims the benefit of and priority to PCT international application No. PCT/CN2023/076948, entitled “TRANSMISSION CONFIGURATION INDICATOR TECHNIQUES” and filed on Feb. 17, 2023, which is expressly incorporated by reference herein in its entirety.

### TECHNICAL FIELD

The present disclosure relates generally to wireless communication, and more particularly, to transmission configuration indicator (TCI) techniques.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (5G UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, etc.) based on multiple-access technologies, such as orthogonal frequency division multiple access (OFDMA) technologies, that support communication with multiple UEs. Improvements in mobile broadband continue the progression of such wireless communication technologies. For example, determining an action time for a TCI indication may be of increased complexity.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, and a user equipment (UE) utilize analog beamforming to increase the link budget. The network entity and the UE may maintain a plurality of beams. A strong network-UE beam pair can greatly increase the link budget, thus providing significant coverage gain. The beam selection procedure is generally performed in two steps: 1) beam measurement and report; and 2) beam indication. The network entity can indicate the beam by indicating one of the transmission configuration indicator (TCI) states in a TCI state list configured by radio resource control (RRC) signaling.

For the unified TCI based beam indication, the network entity can indicate a joint TCI to update the beam for both uplink and downlink channels or separately indicate a downlink TCI to update the beam for downlink channels and/or an uplink TCI to update the beam for uplink channels. The network entity can configure a TCI state list for a bandwidth part by RRC signaling and activate a subset of TCI states from the TCI state list by a medium access control-control element (MAC-CE). The activated TCI states may correspond to different TCI-codepoints. Then, if the activated TCI states correspond to more than one TCI-codepoint, the network entity can transmit a downlink control information (DCI) to indicate the TCI state(s) corresponding to one of the TCI-codepoints for further communication.

For the TCI indication, the network entity can configure the action delay by RRC signaling. However, in some scenarios, such as for non-terrestrial networks (NTNs), the propagation delay could be so large, such that the action delay may not be sufficient for downlink beam indication. Accordingly, there may be a mismatch between the transmit beam of the network entity and the receive beam of the UE for the physical downlink shared channel (PDSCH). The mismatch is the result of the UE applying the updated TCI state for PDSCH reception but the network entity applying the previous TCI state for PDSCH transmission since the network entity has not yet received the acknowledgment (ACK) from the UE for the updated TCI before transmitting the PDSCH. However, the action delay may be sufficient for the uplink beam indication for the physical uplink shared channel (PUSCH) since UE will apply the updated TCI state for the PUSCH transmission and the network will apply the updated TCI state for the PUSCH reception.

The present disclosure addresses the above-noted and other deficiencies by using a second action delay for the TCI indication. The UE may report the UE capability indicating the supported second action delay for the scenario with large propagation delay, e.g., NTN. Based on the received UE capability, the network entity transmits RRC signaling configuring at least a TCI state list and optionally configuring a first action delay for the DCI based beam indication (e.g., TCI indication). The network entity may further transmit a MAC CE activating a subset of TCI states from the configured TCT state list. The network entity then further transmits a DCI indicating at least one TCI state from the activated TCI states. The network entity configures or indicates the second action delay for the DCI based TCI indication by the RRC signaling, MAC CE, or DCI. The network entity and UE may determine the action time based on the first action delay and/or the second action delay and start to communicate with each other based on the indicated at least one TCI state at or after the action time.

According to some aspects, a UE receives, from a network entity, an RRC signaling configuring a list of TCI states and a first action delay. The UE receives, from the network entity, a DCI including a DCI based TCI indication indicating at least one TCI state from the list of TCI states. The UE transmits, to the network entity, an ACK for the DCI based TCI indication. The UE communicates, with the network entity, based on an action time associated with the at least one TCI state, wherein the action time is based on at least a second action delay for the DCI based TCI indication.

According to some aspects, a network entity transmits, to a UE, an RRC signaling configuring a list of TCI states and a first action delay. The network entity transmits, to the UE, a DCI including a DCI based TCI indication indicating at least one TCI state from the list of TCI states. The network entity receives, from the UE, an ACK for the DCI based TCI indication. The network entity communicates, with the UE, based on an action time associated with the at least one TCI state, wherein the action time is based on at least a second action delay for the DCI based TCT indication.

Advantageously, the UE and the network entity support the TCI indication with different scenarios, resulting in improved scheduling flexibility to the network. For example, the network can indicate the TCI by DCI in NTN scenario with large propagation delays. Such techniques can reduce the TCT indication latency, e.g., the network can transmit the TCI indication signaling at any time. The reduced TCI indication latency can also help to improve the system performance, since the network entity and UE can apply improved beams with lower latency.

### BRIEF DESCRIPTION OF THE DRAWINGS

FIG. 1 illustrates a diagram of a wireless communications system that includes a plurality of user equipments (UEs) and network entities in communication over one or more cells according to an embodiment.

FIG. 2 illustrates an example for TCI indication for a single TRP (sTRP) operation according to an embodiment.

FIG. 3 illustrates an example for TCI indication for a multiple TRPs (mTRP) operation according to an embodiment.

FIG. 4A illustrates a diagram for a TCI indication with regard to a large propagation delay according to an embodiment.

FIG. 4B illustrates a diagram for a TCI indication with regard to a large propagation delay according to another embodiment.

FIG. 5 illustrates a signaling diagram for a TCI indication with regard to a large propagation delay according to an embodiment.

FIG. 6 illustrates a flow diagram at a UE for a TCI indication with regard to a large propagation delay according to an embodiment.

FIG. 7 illustrates a flow diagram at a network entity for a TCI indication with regard to a large propagation delay according to an embodiment.

FIG. 8 illustrates a method of wireless communication at a UE for a TCI indication with regard to a large propagation delay according to some embodiments.

FIG. 9 illustrates a method of wireless communication at a network entity for a TCI indication with regard to a large propagation delay according to some embodiments.

FIG. 10 is a diagram illustrating a hardware implementation for an example UE apparatus according to some embodiments.

FIG. 11 is a diagram illustrating a hardware implementation for one or more example network entities according to some embodiments.

### DETAILED DESCRIPTION

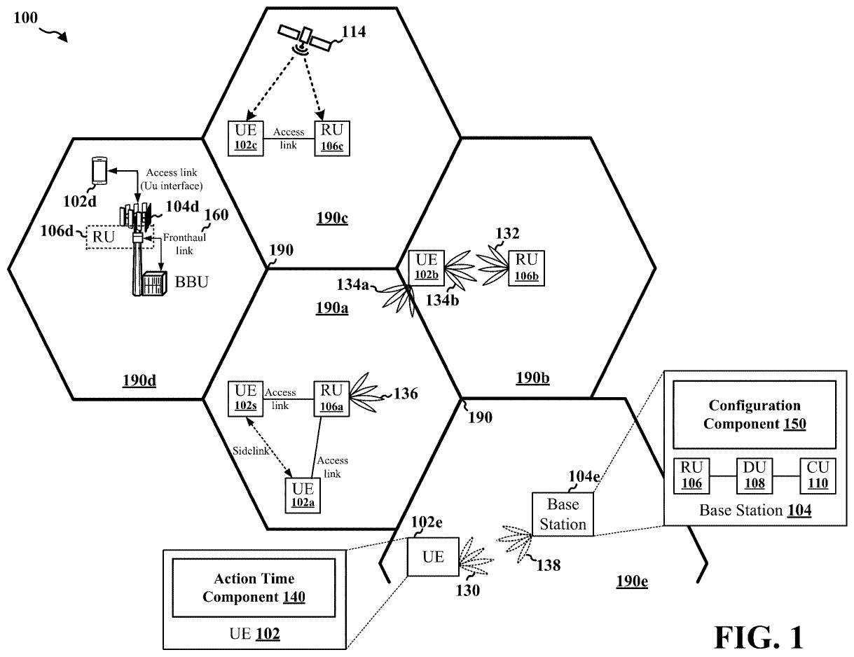

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d, 104e and/or the RUs 106a, 106b, 106c, 106d may communicate with the UEs 102a, 102b, 102c, 102d, and/or 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of YMHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 associated with the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include an action time component 140 configured to receive, from a network entity, an RRC signaling configuring a list of TCI states and a first action delay. The action time component 140 is configured to receive, from the network entity, a DCI including a DCI based TCI indication indicating at least one TCI state from the list of TCI states. The action time component 140 is configured to transmit, to the network entity, an ACK for the DCI based TCI indication. The action time component 140 is configured to communicate, with the network entity, based on an action time associated with the at least one TCI state. The action time is based on at least a second action delay for the DCI based TCI indication.

In certain aspects, any of the base stations 104 or a network entity of the base stations 104 may include a configuration component 150 configured to transmit, to a UE, an RRC signaling configuring a list of TCT states and a first action delay. The configuration component 150 is configured to transmit, to the UE, a DCI including a DCI based TCI indication indicating at least one TCI state from the list of TCI states. The configuration component 150 is configured to receive, from the UE, an ACK for the DCI based TCI indication. The configuration component 150 is configured to communicate, with the UE, based on an action time associated with the at least one TCI state. The action time is based on at least a second action delay for the DCI based TCI indication.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

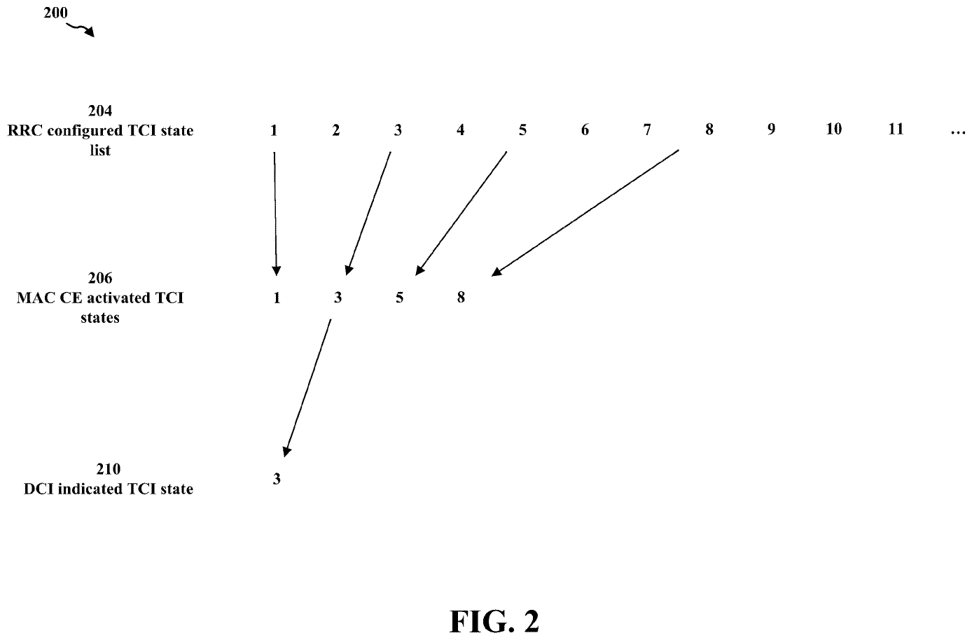

FIG. 2 illustrates a diagram 200 of an example for TCI indication for a single TRP (sTRP) according to an embodiment. To increase the link budget, analog beamforming can be utilized at the network entity and UE side. The network entity and UE may maintain a plurality of beams. A good network-UE beam pair can greatly increase the link budget, thus providing significant coverage gain. The beam selection procedure is generally performed in two steps: 1) beam measurement and report, and 2) beam indication. The network entity can indicate the beam by indicating one of the TCI states in a TCT state list configured by RRC signaling. The network can configure different quasi-co-location (QCL) source reference signal for different TCI states. In one example, the QCL source reference signal may be a synchronization signal block (SSB). The SSB may be from the serving cell (e.g., the SSB is based on a physical cell identifier (PCI) from the serving cell) or a neighbor cell (e.g., the SSB is based on a PCI other than the PCI from the serving cell). In another example, the QCL source reference signal may be a channel state information reference signal (CSI-RS). The CSI-RS may be quasi-co-located with an SSB from the serving cell or a neighbor cell.

For the unified TCI based beam indication, the network entity can indicate a joint TCI to update the beam for both uplink and downlink channels or indicate a downlink TCI to update the beam for downlink channels and/or an uplink TCI to update the beam for uplink channels. The network entity can configure a TCI state list for a bandwidth part (BWP) by RRC signaling and activate a subset of TCI states of the TCI state list by MAC-CE. The activated TCI states correspond to different TCI-codepoints in downlink control information (DCI). If the subset of activated TCI states corresponds to more than one TCI-codepoint, the network entity can transmit a DCI to select the TCI state(s) from the subset of activated TCI states corresponding to one TCI-codepoint for further communication; otherwise, the network entity and UE use the TCI state corresponding to the one TCI-codepoint for further communication after applying the TCI activation signaling.

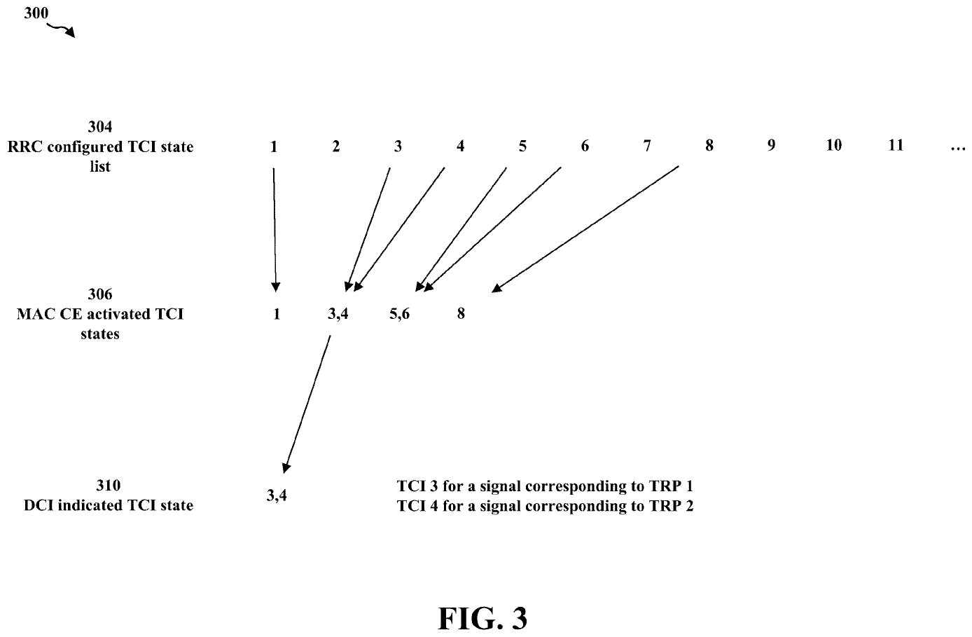

Referring to FIG. 2, the network entity may configure a TCI state list for a BWP by RRC signaling 204. The TCI state list may include TCI 1-TCI 11, etc. The network entity may activate a subset of TCI states of the TCI state list by MAC-CE 206. For example, the subset of TCI states includes TCI 1, TCI 3, TCI 5, and TCI 8. If the activated subset of TCI states (e.g., TCI 1, TCI 3, TCI 5, and TCI 8) correspond to more than one TCI-codepoint, the network entity may transmit 210 a DCI to select one or more TCI states from the subset of activated TCI states corresponding to one TCI-codepoint for further communication. Continuing with the example, the network entity may transmit 210 the DCI to select a TCI state, e.g., TCI 3. FIG. 2 illustrates the example for the TCI indication for the sTRP operation. FIG. 3 illustrates an example for a TCI indication for a multiple TRPs (mTRP) operation.

FIG. 3 illustrates a diagram 300 of an example for a TCI indication for an mTRP operation according to an embodiment. The difference between FIG. 2 and FIG. 3 is that: the network entity only indicates one TCI state in FIG. 2; the network entity indicates multiple TCI states and each indicated TCI state can correspond to a signal for one TRP in FIG. 3.

Referring to FIG. 3, the network entity may configure a TCI state list for a BWP by RRC signaling 304. The TCI state list may include TCI 1-TCI 11, etc. The network entity may activate a subset of TCI states of the TCI state list by MAC-CE 306. For example, the subset of TCI states includes TCI 1, TCI 3 and TCI 4, TCI 5 and TCI 6, and TCI 8. If the activated subset of TCI states corresponds to more than one TCI-codepoint, the network entity may transmit 310 a DCI to select one or more TCI states from the subset of activated TCI states corresponding to one TCI-codepoint for further communication. Continuing with the example, the network entity may transmit 310 the DCI to select two TCI states, e.g., TCI 3 for a signal corresponding to TRP 1 and TCI 4 for a signal corresponding to TRP 2.

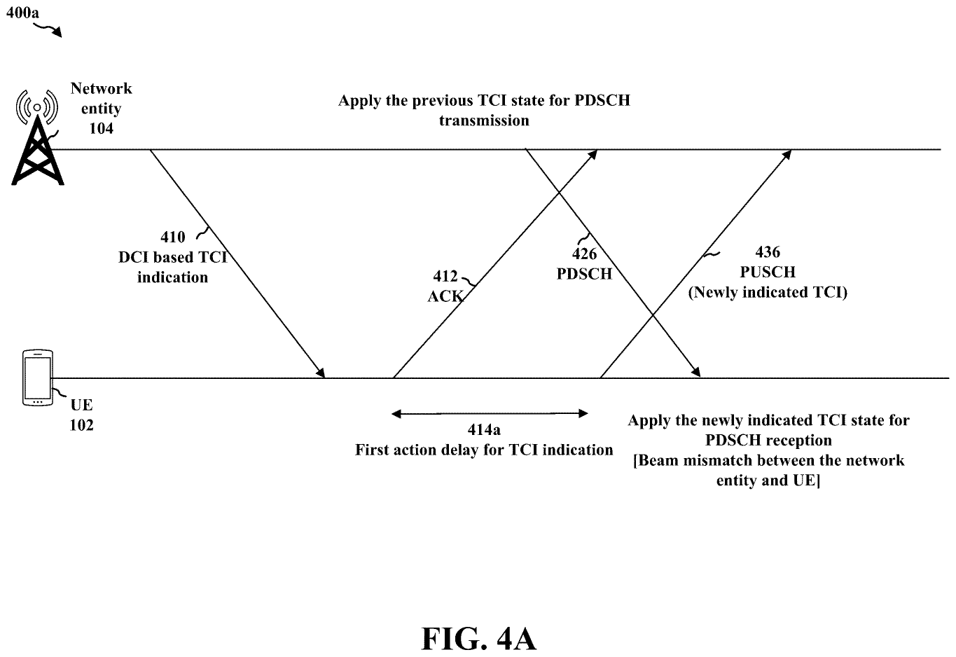

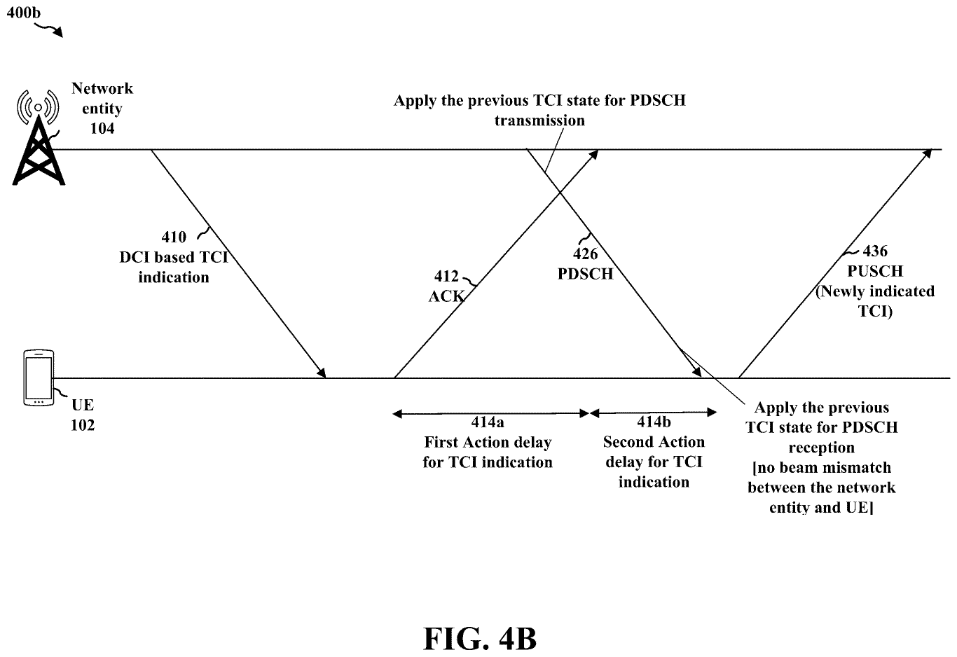

FIG. 4A illustrates a diagram 400a for a TCI indication with regard to a large propagation delay. For the TCI indication, the network entity can configure the action delay by RRC signaling. However, in some scenarios, such as NTN scenarios, the propagation delay could be so large that the action delay could not be sufficient for downlink beam indication. But the action delay could still be sufficient for uplink beam indication.

Referring to FIG. 4A, the network entity 104 may configure a TCI state list by RRC signaling and activate a subset of TCI states of the TCI state list by MAC-CE. For the TCI indication, the network entity can configure a first action delay 414a for the TCI indication by RRC signaling. The network entity 104 transmits 410 a DCI including a DCI based TCI indication to select one or more TCI states from the subset of activated TCI states for further communication. The UE 102 transmits 412, to the network entity, an ACK for the DCI based TCI indication. However, due to the large propagation delay, there may be a mismatch between the transmit beam of the network entity 104 and the receive beam of the UE 102 for a PDSCH 426. As illustrated in FIG. 4A, the network entity 104 may apply the previous TCI state for a PDSCH 426 transmission, since the network entity 104 has not yet received the ACK from the UE for the updated TCI before transmitting the PDSCH 426. The UE 102 may apply the updated TCI state for the PDSCH 426 reception after the first action delay 414a. The mismatch is the result of the UE 102 applying the updated TCI state for the PDSCH 426 reception, but the network entity 104 applying the previous TCI state for PDSCH 426 transmission. Therefore, the first action delay 414a may not be sufficient for downlink beam indication. However, the first action delay 414a may be sufficient for the uplink beam indication for a PUSCH 436 since UE will apply the updated TCI state for the PUSCH 436 transmission and the network will apply the updated TCI state for the PUSCH 436 reception. Providing the beam indication for such kind of scenarios may be of increased complexity.

FIG. 4B illustrates a diagram 400b for a TCI indication with regard to a large propagation delay according to an embodiment. The network entity 104 and UE 102 use a second action delay 414b (e.g., additional delay) for the TCI indication with regard to the large propagation delay. For example, the second action delay is associated with the large propagation delay for NTN or other scenarios. The network entity configures or indicates the second action delay 414b for the DCI based TCI indication by the RRC signaling, MAC CE, or DCI. The network entity and UE may determine the action time for the DCI based TCI indication based on the first action delay and/or the second action delay, and start to communicate with each other based on the indicated at least one TCI state at or after the action time.

Referring to FIG. 4B, the UE 102 receives, from the network entity 104, an RRC signaling configuring the list of TCI states and the first action delay. In some implementations, the UE 102 may further receive, from the network entity, a MAC CE activating a subset of TCI states from the configured list of TCI states. The UE 102 receives 410, from the network entity 104, the DCI including the DCI based TCI indication indicating the at least one TCI state from the list of TCI states. The UE 102 transmits 412, to the network entity 104, the ACK for the DCI based TCI indication. The UE 102 communicates, with the network entity, based on an action time associated with the at least one TCI state, wherein the action time is based on at least the second action delay for the DCI based TCI indication. As illustrated in FIG. 4B, by using the second action delay 414b (e.g., additional delay), there will be no mismatch between the transmit beam of the network entity 104 and the receive beam of the UE 102 for the PDSCH 426. The network entity 104 applies the previous TCI state for the PDSCH 426 transmission, since the network entity 104 has not yet received the ACK from the UE for the updated TCI before transmitting the PDSCH 426. The UE 102 also applies the previous TCI state for the PDSCH 426 reception before the second action delay 414b. Therefore, there is no beam mismatch between the transmit beam of the network entity 104 and the receive beam of the UE 102 for the PDSCH 426. The action time based on the first action delay 414a and/or the second action delay 414b may be sufficient for the TCI indication for the PUSCH 426.

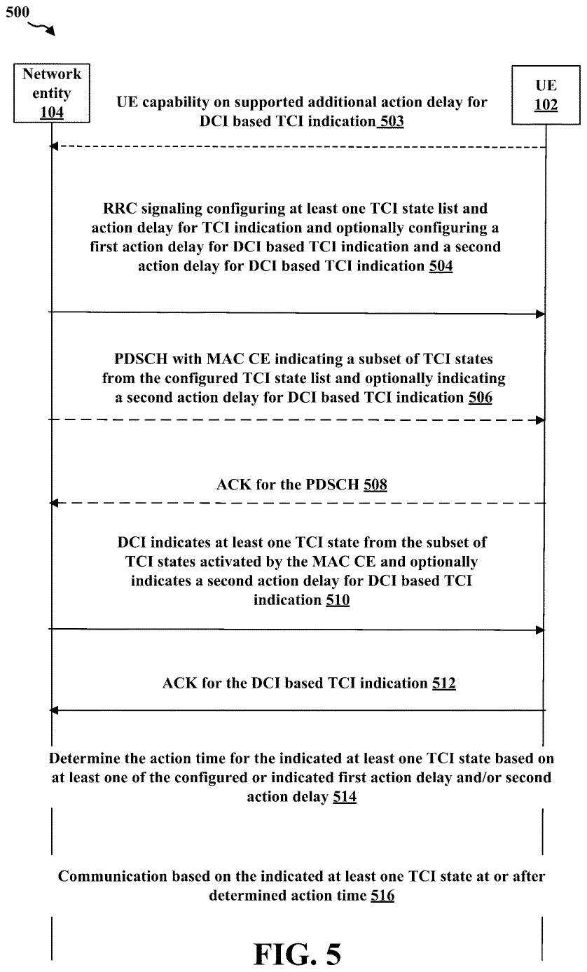

FIG. 5 illustrates a signaling diagram 500 for a TCI indication with an additional action delay (e.g., a second action delay) with regard to a large propagation delay according to an embodiment. The network entity 104 may correspond to a base station or a unit of a base station, such as the RU 106, the DU 108, the CU 110, etc.

The UE may report 503 the UE capability indicating the supported additional action delay (e.g., the second action delay) for DCI based TCI indication. The additional action delay may be associated with the scenario with the large propagation delay (e.g., NTN scenario). The UE may transmit 503 to the network entity (the network entity may receive 503 from the UE), a UE capability report indicating a UE capability including at least one of: whether the UE supports configuring or indicating the second action delay for the DCI based TCI indication (e.g., beam indication), whether the UE supports the second action delay, a supported minimum value of the second action delay, or a supported maximum value of the second action delay. In this disclosure, unless specified, the network entity may receive the UE capability from a UE or from a core network (e.g., access and mobility management Function (AMF)) or another network entity.

Based on the received UE capability, the network entity may transmit 504 a RRC signaling configuring at least one TCI state list, e.g., dl-OrJoint-TCIStateList and/or ul-TCI-StateList. The network entity may configure an action time for the DCI based TCI indication. For example, the network entity configures a first action delay for the DCI based TCI indication (e.g., beam indication). The UE 102 receives 504 from the network entity 104 (the network entity 104 transmits 504 to the UE), the RRC signaling configuring a list of TCI states and a first action delay. In one example, the network entity 104 configures (the UE 102 receives) the second action delay for the DCI based TCI indication by the RRC signaling. In some implementations, for the scenario with large propagation delay, e.g., NTN, the network entity may refrain from configuring the unified TCI state list, e.g., dl-OrJoint-TCIStateList and/or ul-TCI-StateList. The large propagation delay may be a propagation delay larger than a predetermined threshold. For example, the predetermined threshold is 1 symbol or 1 slot. The network entity may refrain from configuring the unified TCI state list if it does not configure the second action delay. Therefore, in some implementations, the UE may not expect the network entity configure the unified TCI state list, e.g., dl-OrJoint-TCIStateList and/or ul-TCI-StateList, for the scenario with large propagation delay, e.g., NTN.

The network entity may transmit 506 an MAC-CE activating a subset of TCI states from the configured at least one TCI state list. The UE may receive 506, from the network entity (the network entity may transmit 506, to the UE), on a PDSCH, the MAC-CE activating the subset of TCI states of the list of TCI states. The UE may transmit 508 to the network entity (the network entity may receive 508 from the UE) an ACK for the PDSCH with the MAC-CE.

The network entity further transmits 510 a DCI indicating at least one TCI state from the activated TCI states. The UE receives 510 from the network entity (the network entity transmits 510 to the UE), the DCI including a DCI based TCI indication indicating at least one TCI state from the list of TCI states. The at least one TCI state is from the activated subset of TCI states. The UE transmits 512 to the network entity (the network entity receives 512 from the UE), an ACK for the DCI based TCI indication.

The network entity may configure or indicate the second action delay (e.g., the additional action delay) for the DCI based TCI indication by the RRC signaling 504, the MAC-CE 506, or the DCI 510. The network entity and UE may determine 514 the action time associated with the at least one TCI state based on the first action delay and/or the second action delay. For example, the action time associated with the at least one TCI state refers to a time when the UE or the network entity applies the at least one TCI state indicated in the DCI, which is an action time for the DCI based TCI indication. The UE or the network entity may apply the indicated at least one TCI state at or after the action time associated with the at least one TCI state. The UE or the network entity may apply the indicated at least one TCI state based on the action time associated with the at least one TCI state, which is the action time for the DCI based TCI indication.

The UE or the network entity may start to communicate 516 with each other based on the indicated at least one TCI state at or after the action time. The UE 102 communicates 516 with the network entity (the network entity communicates 516 with the UE), based on the action time associated with the at least one TCI state. The action time associated with the at least one TCI state is based on at least the second action delay for the DCI based TCI indication. The first action delay may be a first time duration to delay applying the indicated at least one TCI state. The second action delay may be a second time duration to delay applying the indicated at least one TCI state. For example, the action time associated with the at least one TCI state is based on at least one of the first action delay, the second action delay, or a sum of the first action delay and the second action delay.

In a first example, the network entity configures the second action delay by a RRC signaling. In this disclosure, unless specified, a RRC signaling from the network entity to UE may indicate a RRC reconfiguration message, or a system information block (SIB), where the SIB can be an existing SIB (e.g., SIB1) or a new SIB (e.g., SIB J, where J is an integer above 21) transmitted by the network entity. A RRC signaling from the UE to UE may indicate UE forwarded a RRC reconfiguration message. The second action delay may be configured in units of slots or symbols based on a reference subcarrier spacing, e.g., 15 kHz, or the configured subcarrier spacing. The second action delay may also be configured in units of millisecond, subframes, or frames.

In a second example, the network entity configures the second action delay by MAC-CE indication. The network entity may configure the second action delay in the MAC-CE for TCI activation. The second action delay may be configured in units of slots or symbols based on a reference subcarrier spacing, e.g., 15 kHz, or the configured subcarrier spacing. The second action delay may also be configured in units of milliseconds, subframes, or frames. In some examples, the network entity indicates a common second action delay for all the activated TCI states. In some other examples, the network entity indicates separate second action delays for the activated TCI states corresponding to different TCI-codepoints. In still some other examples, the network entity indicates the separate second action delays for each activated TCI state.

In a third example, the network entity configures the second action delay by DCI indication. The network entity may configure the second action delay in the DCI for TCI indication. The second action delay may be configured in units of slots or symbols based on a reference subcarrier spacing, e.g., 15 kHz, or the configured subcarrier spacing. The second action delay may also be configured in units of milliseconds, subframes, or frames. The network entity may indicate the second action delay by a field, e.g., additional action delay for TCI indication, in the DCI. The network entity may also indicate whether to apply the second action delay by a field, e.g., a flag to apply additional action delay for TCI indication, in the DCI, where the value of the second action delay may be configured by RRC signaling as in the first example or by MAC-CE as in the second example.

In some examples, for the serving cells configured in a serving cell list that share common TCI ID update signaling, the network entity indicates the same second action delay to make sure the action time for the common TCI ID update is the same for such serving cells. Thus, the network entity may configure the same second action delay for all the serving cells in the serving cell list that share the common TCI ID update signaling. In some other examples, for the serving cells configured in a serving cell list that share the common TCI ID update signaling, the network entity and UE determine the second action delay of the serving cells in the serving cell list based on a second action delay indicated for one serving cell of the serving cells in the serving cell list. The one serving cell may have a predefined serving cell index, e.g., the one with the lowest/highest serving cell index, the one with the MAC-CE for TCI activation, the one with the DCI for TCI indication, or may be configured by the network entity via RRC signaling.

In some examples, the action time is be determined based on a sum of the first action delay and the second action delay. The network entity and UE may determine 514 the action time for the DCI based TCI indication based on a total action delay from the first and second action delay. If the second action delay is not configured, the UE and network entity may determine the second action delay based on a predefined value, e.g., 0. If the first action delay is not configured, the UE and network entity may determine the first action delay based on a predefined value, e.g., 0.

In some implementations, when the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI state indication, and if the indicated TCI state is different from the previously indicated TCI state, the indicated DLorJointTCIState or UL-TCIstate should be applied starting from the first slot that is at least

$$beamAppTime + \frac{{2}^{μ}}{{2}^{{μ}_{{K}_{mac}}}} \cdot {k}_{mac} {N}_{sym}^{slot}$$

symbols after the last symbol of the PUCCH or the PUSCH, where μ is the SCS configuration for the PUCCH or the PUSCH and μ_{K}_{_{mac}} is the subcarrier spacing configuration for k_{mac} with a value of 0 for frequency range 1, and k_{mac} is provided by Kmac or k_{mac}=0 if K-Mac is not provided, and

$${N}_{sym}^{slot}$$

is the number of symbols per slot. The first slot and the beamAppTime symbols are both determined on the active BWP with the smallest SCS among the active BWP(s) of the carrier(s) applying the beam indication.

In some other implementations, when the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI state indication, and if the indicated TCI dtate is different from the previously indicated TCI state, the indicated DLorJointTCIState or UL-TCIstate should be applied starting from the first slot that is at least

$$beamAppTime + \frac{{2}^{μ}}{{2}^{{μ}_{{K}_{mac}}}} \cdot {k}_{mac} {N}_{sym}^{slot}$$

symbols after the last symbol of the PUCCH or the PUSCH transmission occasion with HARQ-ACK information, where μ is the SCS configuration for the PUCCH or the PUSCH and μ_{K}_{_{mac}} is the subcarrier spacing configuration for k_{mac} with a value of 0 for frequency range 1, and k_{mac} is provided by Kmac or k_{mac}=0 if K-Mac is not provided, and

$${N}_{sym}^{slot}$$

is the number of symbols per slot. The first slot and the beamAppTime symbols are both determined on the active BWP with the smallest SCS among the active BWP(s) of the carrier(s) applying the beam indication.

If the first action delay is not configured, the UE and network entity may determine the first action delay based on a predefined value, e.g., 0. In some examples, when the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI State indication, and if the indicated TCI state is different from the previously indicated TCI state, the indicated DLorJointTCIState or UL-TCIstate should be applied starting from the first slot that is at least beamAppTime symbols after the last symbol of the PUCCH or the PUSCH. If the beamAppTime is not configured, the UE shall assume beamAppTime should be 0. The first slot and the beamAppTime symbols are both determined on the active BWP with the smallest SCS among the active BWP(s) of the carrier(s) applying the beam indication.

In some examples, the action time is determined based on one of the first action delay or the second action delay. That is, the network entity and UE may determine the action time for the DCI based TCI indication based on the action delay from one of the first action delay or the second action delay. If the second action delay is not configured but the first action delay is configured, the UE and network entity may determine the action time based on the first action delay. If the second action delay is configured but the first action delay is not configured, the UE and network entity may determine the action time based on the second action delay. If the first action delay and the second action delay are configured, the UE and network entity may determine the action time based on a predefined delay, e.g., 0. If the first action delay and the second action delay are configured, the network entity could further indicate or configure the UE which action delay to apply, the first action delay or the second action delay. The network entity may also refrain from configuring both the first action delay and the second action delay. In some examples, the UE and network entity may determine the action time based on the maximum or minimum delay from the first action delay and second action delay.

In some examples, the network entity configures whether the UE will apply the action time based on the total delay from the first and second configured delay, or the maximum/minimum delay from the first and second action delay by RRC signaling, MAC-CE, or DCI. The UE may report a UE capability indicating the supported action time determination scheme.

In some examples, the action delay is determined based on the indicated TCI states. In one example, if the indicated TCI state is only a downlink TCI state, the UE applies the action time based on the first action delay. Otherwise, the UE may determine the action time based on the first action delay and the second action delay as described above. The UE may apply the action time based on the first action delay for the downlink TCI state update and apply the action time based on the first and second action delay, as described above, for an uplink TCI state update. In one example, if the indicated TCI state is only an uplink TCI state, the UE applies the action time based on the first action delay. Otherwise, the UE may determine the action time based on the first action delay and the second action delay as described above. The UE may apply the action time based on the first action delay for the uplink TCI state update and apply the action time based on the first and second action delay, as described above, for a downlink TCI state update.

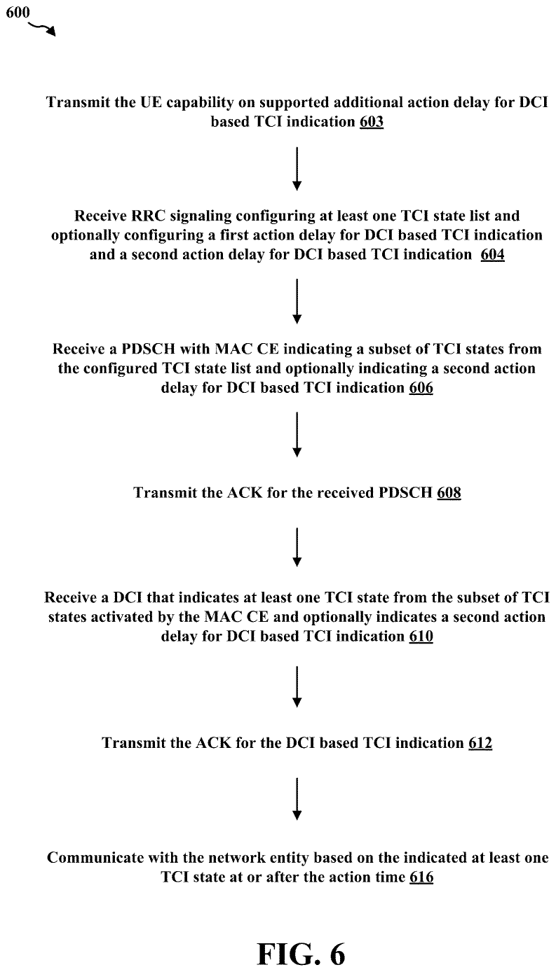

FIG. 6 illustrates a flow diagram 600 at a UE for a TCI indication with regard to a large propagation delay according to an embodiment. More specifically, FIG. 6 illustrates the UE behavior on TCI activation with the additional delay (e.g., second action delay).

Referring to FIG. 6, the UE may report 603 the UE capability indicating the supported additional action delay (e.g., second action delay) for DCI based TCI indication. The additional action delay may be associated with the scenario with the large propagation delay (e.g., NTN scenario). The UE may transmit 603 to the network entity, a UE capability report indicating a UE capability including at least one of: whether the UE supports the second action delay, a supported minimum value of the second action delay, or a supported maximum value of the second action delay.

The UE may receive 604 a RRC signaling configuring at least one TCI state list. The RRC signaling may configure a first action delay for the DCI based TCI indication. In one example, the RRC signaling configures the second action delay for the DCI based TCI indication.

The UE may receive 606 a PDSCH with an MAC-CE activating a subset of TCI states from the configured at least one TCI state list. The UE may receive 606, from the network entity, on a PDSCH, the MAC-CE activating the subset of TCI states of the list of TCI states. In some examples, the MAC-CE may indicate the second action delay for DCI based TCI indication. The UE may transmit 608 to the network entity an ACK for the PDSCH with the MAC-CE.

The UE receives 610 a DCI indicating at least one TCI state from the activated TCI states. The UE receives 610 from the network entity, the DCI including a DCI based TCI indication indicating at least one TCI state from the list of TCI states. In some examples, the DCI may indicate the second action delay for DCI based TCI indication. The UE transmits 612 to the network entity, an ACK for the DCI based TCI indication.

The UE may start to communicate 616 with the network entity based on the indicated at least one TCI state at or after the action time. The UE 102 communicates 616 with the network entity, based on the action time associated with the at least one TCI state.

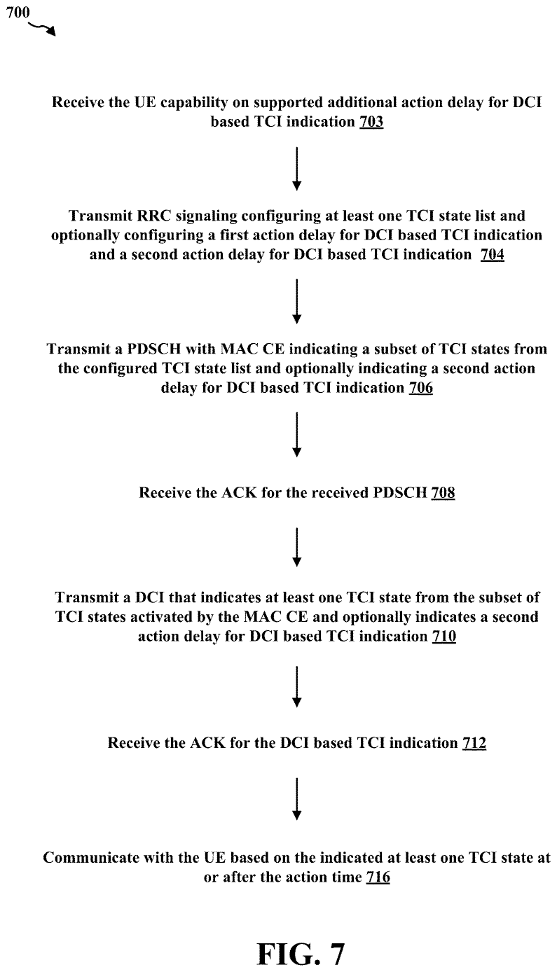

FIG. 7 illustrates a flow diagram 700 at a network entity for a TCI indication with regard to a large propagation delay according to an embodiment. More specifically, FIG. 7 illustrates the network entity behavior on TCI activation with the additional delay (e.g., second action delay).

Referring to FIG. 7, the network entity may receive 703 the UE capability indicating the supported additional action delay (e.g., second action delay) for DCI based TCI indication. The additional action delay may be associated with the scenario with the large propagation delay (e.g., NTN scenario). The network entity may receive 703 from the UE, a UE capability report indicating a UE capability including at least one of: whether the UE supports the second action delay, a supported minimum value of the second action delay, or a supported maximum value of the second action delay.

Based on the received UE capability, the network entity may transmit 704 a RRC signaling configuring at least one TCI state list. The network entity may configure 704 a first action delay for the DCI based TCI indication. In one example, the network entity 104 configures the second action delay for the DCI based TCI indication by the RRC signaling.

The network entity may transmit 706 a PDSCH with an MAC-CE activating a subset of TCI states from the configured at least one TCI state list. The network entity may transmit 706, to the UE, on a PDSCH, the MAC-CE activating the subset of TCI states of the list of TCI states. In some examples, the MAC-CE may indicate the second action delay for DCI based TCI indication. The network entity may receive 708 from the UE an ACK for the PDSCH with the MAC-CE.

The network entity transmits 710 a DCI indicating at least one TCI state from the activated TCI states. The network entity transmits 710 to the UE, the DCI including a DCI based TCI indication indicating at least one TCI state from the list of TCI states. In some examples, the DCI may indicate the second action delay for DCI based TCI indication. The network entity receives 712 from the UE, an ACK for the DCI based TCI indication.

The network entity may start to communicate 716 with the UE based on the indicated at least one TCI state at or after the action time. The network entity communicates 716 with the UE, based on the action time associated with the at least one TCI state.

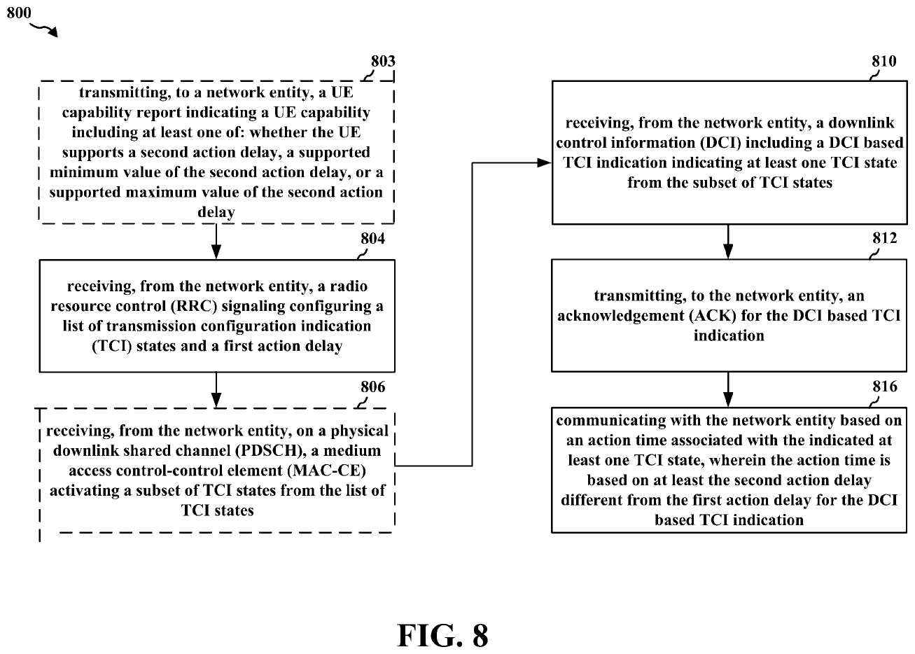

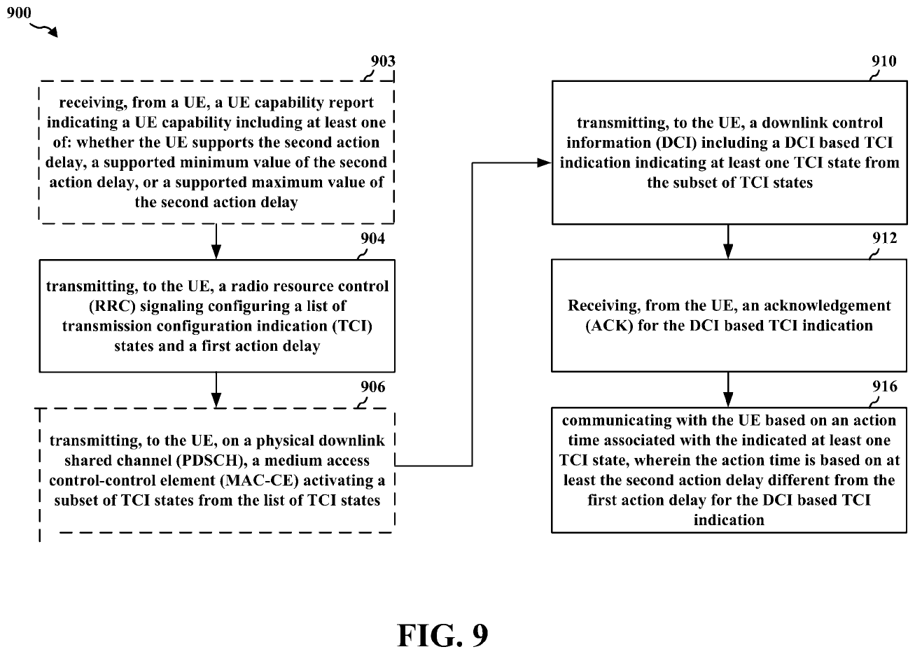

FIGS. 2-3 illustrate examples for TCI indication. FIGS. 4A-4B illustrate examples for the TCI indication with regard to the large propagation delay. FIGS. 5-7 illustrate flow diagrams for the TCI indication with regard to the large propagation delay. FIGS. 8-9 show methods for implementing one or more aspects of FIGS. 2-7. In particular, FIG. 8 shows an implementation by the UE 102 of the one or more aspects of FIGS. 2-7. FIG. 9 shows an implementation by the network entity 104 of the one or more aspects of FIGS. 2-7.

FIG. 8 illustrates a flow chart of a method 800 of wireless communication at a UE. With reference to FIGS. 2-7, the method 800 may be performed by the UE 102. The UE 102 may transmit 803, to a network entity, a UE capability report indicating a UE capability including at least one of: whether the UE supports the second action delay, a supported minimum value of the second action delay, or a supported maximum value of the second action delay. For example, referring to FIG. 5, the UE may transmit 503 to the network entity (the network entity may receive 503 from the UE), UE capability on supported additional action delay for DCI based TCI indication.

The UE receives 804, from the network entity, an RRC signaling configuring a list of TCI states and a first action delay. For example, referring to FIG. 5, the UE 102 receives 504 from the network entity 104 (the network entity 104 transmits 504 to the UE), the RRC signaling configuring a list of TCI states and a first action delay.

The UE may receive 806, from the network entity, on a PDSCH, an MAC-CE activating a subset of TCI states from the list of TCI states. For example, referring to FIG. 5, the UE may receive 506, from the network entity (the network entity may transmit 506, to the UE), on a PDSCH, the MAC-CE activating the subset of TCI states of the list of TCI states.

The UE receives 810, from the network entity, a DCI including a DCI based TCI indication indicating at least one TCI state from the list of TC states. For example, referring to FIG. 5, the UE receives 510 from the network entity (the network entity transmits 510 to the UE), the DCI including a DCI based TCI indication indicating at least one TCI state from the list of TCI states.

The UE transmits 812, to the network entity, an ACK for the DCI based TCI indication. For example, referring to FIG. 5, the UE transmits 512 to the network entity (the network entity receives 512 from the UE), an ACK for the DCI based TCI indication.

The UE communicates 816, with the network entity, based on an action time associated with the at least one TCI state. The action time is based on at least a second action delay for the DCI based TCI indication. For example, referring to FIG. 5, the UE 102 communicates 516 with the network entity (the network entity communicates 516 with the UE), based on the action time associated with the at least one TCI state. FIG. 8 describes a method 800 from a UE-side of a wireless communication link, whereas FIG. 9 describes a method 900 from a network-side of the wireless communication link.

FIG. 9 illustrates a flow chart of a method 900 of wireless communication at a network entity. With reference to FIGS. 2-7, the method 900 may be performed by one or more network entities 104, which may correspond to a base station or a unit of the base station, such as the RU 106, the DU 108, and/or the CU 110. The network entity 104 may receive 903, from a UE, a UE capability report indicating a UE capability including at least one of: whether the UE supports the second action delay, a supported minimum value of the second action delay, or a supported maximum value of the second action delay. For example, referring to FIG. 5, the network may receive 503 from the UE (the UE may transmit 503 to the network), UE capability on supported additional action delay for DCI based TCI indication.

The network entity transmits 904, from the UE, an RRC signaling configuring a list of TCI states and a first action delay. For example, referring to FIG. 5, the network entity 104 transmits 504 to the UE, the RRC signaling configuring a list of TCI states and a first action delay.

The network entity may transmit 906, to the UE, on a PDSCH, an MAC-CE activating a subset of TCI states from the list of TCI states. For example, referring to FIG. 5, the network entity may transmit 506, to the UE, on a PDSCH, the MAC-CE activating the subset of TCI states of the list of TCI states.

The network entity transmits 910, to the UE, a DCI including a DCI based TCI indication indicating at least one TCI state from the list of TCI states. For example, referring to FIG. 5, the network entity transmits 510 to the UE, the DCI including a DCI based TCI indication indicating at least one TCI state from the list of TCI states.

The network entity receives 912, from the UE, an ACK for the DCI based TCI indication. For example, referring to FIG. 5, the network entity receives 512 from the UE, an ACK for the DCI based TCI indication.

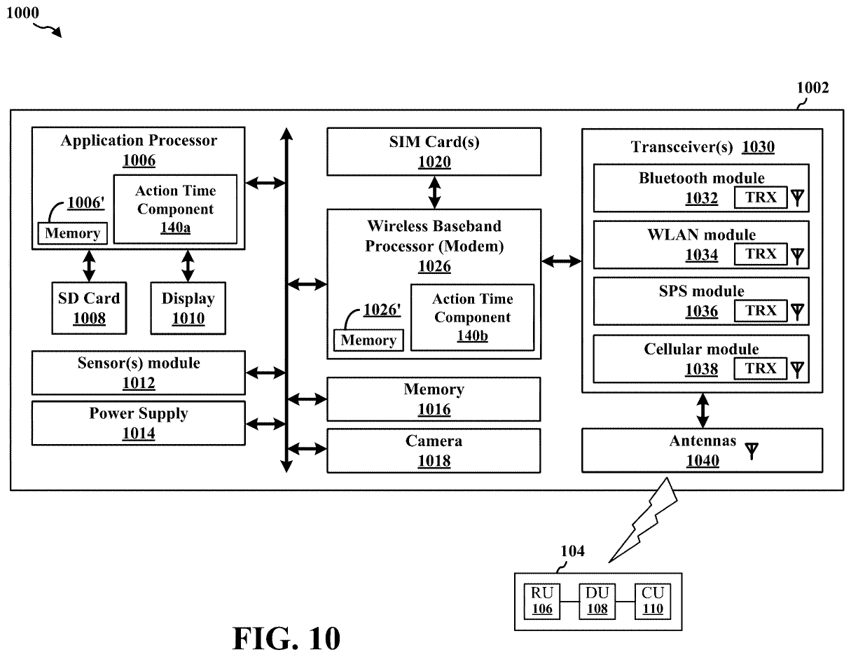

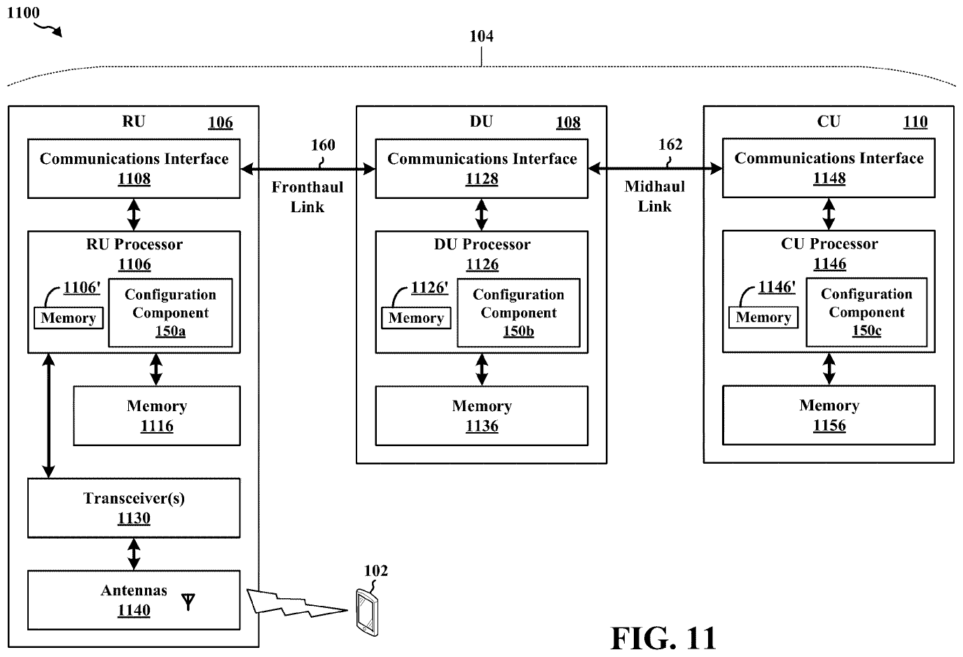

The network entity communicates 916, with the UE, based on an action time associated with the at least one TCI state. The action time is based on at least a second action delay for the DCI based TCI indication. For example, referring to FIG. 5, the network entity communicates 516 with the UE, based on the action time associated with the at least one TCI state. A UE apparatus 1002, as described in FIG. 10, may perform the method 800 of FIG. 8. The one or more network entities 104, as described in FIG. 11, may perform the method 900 of FIG. 9.

FIG. 10 is a diagram 1000 illustrating an example of a hardware implementation for a UE apparatus 1002. The UE apparatus 1002 may be the UE 102, a component of the UE 102, or may implement UE functionality. The UE apparatus 1002 may include an application processor 1006, which may have on-chip memory 1006′. In examples, the application processor 1006 may be coupled to a secure digital (SD) card 1008 and/or a display 1010. The application processor 1006 may also be coupled to a sensor(s) module 1012, a power supply 1014, an additional module of memory 1016, a camera 1018, and/or other related components.

The UE apparatus 1002 may further include a wireless baseband processor 1026, which may be referred to as a modem. The wireless baseband processor 1026 may have on-chip memory 1026′. Along with, and similar to, the application processor 1006, the wireless baseband processor 1026 may also be coupled to the sensor(s) module 1012, the power supply 1014, the additional module of memory 1016, the camera 1018, and/or other related components. The wireless baseband processor 1026 may be additionally coupled to one or more subscriber identity module (SIM) card(s) 1020 and/or one or more transceivers 1030 (e.g., wireless RF transceivers).

Within the one or more transceivers 1030, the UE apparatus 1002 may include a Bluetooth module 1032, a WLAN module 1034, an SPS module 1036 (e.g., GNSS module), and/or a cellular module 1038. The Bluetooth module 1032, the WLAN module 1034, the SPS module 1036, and the cellular module 1038 may each include an on-chip transceiver (TRX), or in some cases, just a transmitter (TX) or just a receiver (RX). The Bluetooth module 1032, the WLAN module 1034, the SPS module 1036, and the cellular module 1038 may each include dedicated antennas and/or utilize antennas 1040 for communication with one or more other nodes. For example, the UE apparatus 1002 can communicate through the transceiver(s) 1030 via the antennas 1040 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1026 and the application processor 1006 may each include a computer-readable medium/memory 1026′, 1006′, respectively. The additional module of memory 1016 may also be considered a computer-readable medium/memory. Each computer-readable medium/memory 1026′, 1006′, 1016 may be non-transitory. The wireless baseband processor 1026 and the application processor 1006 may each be responsible for general processing, including execution of software stored on the computer-readable medium/memory 1026′, 1006′, 1016. The software, when executed by the wireless baseband processor 1026/application processor 1006, causes the wireless baseband processor 1026/application processor 1006 to perform the various functions described herein. The computer-readable medium/memory may also be used for storing data that is manipulated by the wireless baseband processor 1026/application processor 1006 when executing the software. The wireless baseband processor 1026/application processor 1006 may be a component of the UE 102. The UE apparatus 1002 may be a processor chip (e.g., modem and/or application) and include just the wireless baseband processor 1026 and/or the application processor 1006. In other examples, the UE apparatus 1002 may be the entire UE 102 and include the additional modules of the apparatus 1002.

As discussed in FIG. 1 and implemented with respect to FIG. 8, the action time component 140 is configured to receive, from a network entity, an RRC signaling configuring a list of TCI states and a first action delay. The action time component 140 is configured to receive, from the network entity, a DCI including a DCI based TCI indication indicating at least one TCI state from the list of TCI states. The action time component 140 is configured to transmit, to the network entity, an ACK for the DCI based TCI indication. The action time component 140 is configured to communicate, with the network entity, based on an action time associated with the at least one TCI state. The action time is based on at least a second action delay for the DCI based TCI indication. The action time component 140 may be within the application processor 1006 (e.g., at 140a), the wireless baseband processor 1026 (e.g., at 140b), or both the application processor 1006 and the wireless baseband processor 1026. The action time component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 11 is a diagram 1100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1146, which may have on-chip memory 1146′. In some aspects, the CU 110 may further include an additional module of memory 1156 and/or a communications interface 1148, both of which may be coupled to the CU processor 1146. The CU 110 can communicate with the DU 108 through a midhaul link 162, such as an F1 interface between the communications interface 1148 of the CU 110 and a communications interface 1128 of the DU 108.

The DU 108 may include a DU processor 1126, which may have on-chip memory 1126′. In some aspects, the DU 108 may further include an additional module of memory 1136 and/or the communications interface 1128, both of which may be coupled to the DU processor 1126. The DU 108 can communicate with the RU 106 through a fronthaul link 160 between the communications interface 1128 of the DU 108 and a communications interface 1108 of the RU 106.

The RU 106 may include an RU processor 1106, which may have on-chip memory 1106′. In some aspects, the RU 106 may further include an additional module of memory 1116, the communications interface 1108, and one or more transceivers 1130, all of which may be coupled to the RU processor 1106. The RU 106 may further include antennas 1140, which may be coupled to the one or more transceivers 1130, such that the RU 106 can communicate through the one or more transceivers 1130 via the antennas 1140 with the UE 102.

The on-chip memory 1106′, 1126′, 1146′ and the additional modules of memory 1116, 1136, 1156 may each be considered a computer-readable medium/memory. Each computer-readable medium/memory may be non-transitory. Each of the processors 1106, 1126, 1146 is responsible for general processing, including execution of software stored on the computer-readable medium/memory. The software, when executed by the corresponding processor(s) 1106, 1126, 1146 causes the processor(s) 1106, 1126, 1146 to perform the various functions described herein. The computer-readable medium/memory may also be used for storing data that is manipulated by the processor(s) 1106, 1126, 1146 when executing the software. In examples, the configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 9, the configuration component 150 is configured to transmit, to a UE, an RRC signaling configuring a list of TCI states and a first action delay. The configuration component 150 is configured to transmit, to the UE, a DCI including a DCI based TCI indication indicating at least one TCI state from the list of TCI states. The configuration component 150 is configured to receive, from the UE, an ACK for the DCI based TCI indication. The configuration component 150 is configured to communicate, with the UE, based on an action time associated with the at least one TCI state. The action time is based on at least a second action delay for the DCI based TCI indication. The configuration component 150 may be within one or more processors of the one or more network entities 104, such as the RU processor 1106 (e.g., at 150a), the DU processor 1126 (e.g., at 150b), and/or the CU processor 1146 (e.g., at 150c). The configuration component 150a-150c may be one or more hardware components specifically configured to carry out the stated processes/algorithm, implemented by one or more processors 1106, 1126, 1146 configured to perform the stated processes/algorithm, stored within a computer-readable medium for implementation by the one or more processors 1106, 1126, 1146, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more. Terms or articles such as “a”, “an”, and/or “the” may refer to one of an item, feature, element, etc., that the term or article precedes, or may refer to more than one of said item, feature, element, etc. that the term or article precedes. For example, the recitation “a widget” does not preclude reference to multiples of said widget, as “multiple widgets” necessarily includes “a widget”. Hence, the recitation “a widget” may be interpreted as “at least one widget” or, similarly, interpreted as “one or more widgets”.

Unless otherwise specifically indicated, ordinal terms such as “first” and “second” do not necessarily imply an order in time, sequence, numerical value, etc., but are used to distinguish between different instances of a term or phrase that follows each ordinal term.

Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers but have one or more of the same trailing numbers (e.g., 206, 306, 406, etc., may refer to similar features in the drawings). Hence, like numbers may refer to like actions.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, an RRC signaling configuring a list of TCI states and a first action delay; receiving, from the network entity, a DCI including a DCI based TCI indication indicating at least one TCI state from the list of TCI states; transmitting, to the network entity, an ACK for the DCI based TCI indication; and communicating, with the network entity, based on an action time associated with the at least one TCI state, the action time is based on at least a second action delay for the DCI based TCI indication.

Example 2 may be combined with example 1 and includes that receiving, from the network entity, on a PDSCH, an MAC-CE activating a subset of TCI states of the list of TCI states, the at least one TCI state is from the activated subset of TCI states.

Example 3 may be combined with any of the examples 1-2 and further includes that the second action delay is associated with a propagation delay, and the network entity is associated with a NTN.

Example 4 may be combined with any of examples 1-3 and further includes that applying the at least one TCI state at the action time or after the action time.

Example 5 may be combined with any of examples 1-4 and further includes that transmitting, to the network entity, a UE capability report indicating a UE capability including at least one of: whether the UE supports the second action delay, a supported minimum value of the second action delay, or a supported maximum value of the second action delay.

Example 6 may be combined with any of examples 2-5 and includes that the second action delay is configured via the RRC signaling, the MAC-CE, or the DCI.

Example 7 may be combined with any of examples 1-5 and includes that the DCI includes a field that indicates whether to apply the second action delay.

Example 8 may be combined with any of examples 1-7 and includes that the action time is based on at least one of the first action delay, the second action delay, or a sum of the first action delay and the second action delay.

Example 9 is a method of wireless communication at a network entity, including transmitting, to a UE, an RRC signaling configuring a list of TCI states and a first action delay; transmitting, to the UE, a DCI including a DCI based TCI indication indicating at least one TCI state from the list of TCI states; receiving, from the UE, an ACK for the DCI based TCI indication; and communicating, with the UE, based on an action time associated with the at least one TCI state, wherein the action time is based on at least a second action delay for the DCI based TCI indication.

Example 10 may be combined with example 9 and includes that transmitting, to the UE on a PDSCH, an MAC-CE activating a subset of TCI states of the list of TCI states, wherein the at least one TCI state is from the activated subset of TCI states.

Example 11 may be combined with any of the examples 9-10 and further includes that the second action delay is associated with a propagation delay, and the network entity is associated with a NTN.

Example 12 may be combined with any of examples 9-11 and further includes that receiving, from the UE, a UE capability report indicating a UE capability including at least one of: whether the UE supports the second action delay, a supported minimum value of the second action delay, or a supported maximum value of the second action delay.

Example 13 may be combined with any of examples 10-12 and includes that the RRC, the MAC-CE, or the DCI signaling configures the second action delay.

Example 14 may be combined with any of examples 9-12 and includes that the DCI includes a field that indicates whether to apply the second action delay.

Example 15 may be combined with any of examples 9-14 and includes that the action time is based on at least one of the first action delay, the second action delay, or a sum of the first action delay and the second action delay.

Example 16 may be combined with any of examples 1-8 and further includes that receiving, from the network entity, a configuration of the second action delay based on the network entity is associated with an NTN.

Example 17 may be combined with any of examples 9-15 and further includes that transmitting, to the UE, a configuration of the second action delay based on the network entity is associated with an NTN.

Example 18 may be combined with example 17 and includes that the list of TCI states includes a unified TCI state, the example further includes: refraining from transmitting, to the UE, a configuration of the unified TCI state, before the transmitting, to the UE, the configuration of the second action delay.

Example 19 is an apparatus for wireless communication comprising a transceiver, a memory, and a processor coupled to the memory and the transceiver, the apparatus being configured to implement a method as in any of claims 1-18.

Example 20 is an apparatus for wireless communication including means for implementing a method as in any of examples 1-18.

Example 21 is a non-transitory computer-readable medium storing computer executable code, the code when executed by a processor causes the processor to implement a method as in any of examples 1-18.

1. A method of wireless communication at a user equipment (UE), comprising:
receiving, from a network entity, a radio resource control (RRC) signaling configuring a list of transmission configuration indicator (TCI) states and a first action delay;
receiving, from the network entity, a downlink control information (DCI) including a DCI based TCI indication indicating at least one TCI state from the list of TCI states;
transmitting, to the network entity, an acknowledgement (ACK) for the DCI based TCI indication; and
communicating, with the network entity, based on an action time associated with the at least one TCI state, wherein the action time is based on at least a second action delay different from the first action delay for the DCI based TCI indication.

2. The method of claim 1, further comprising:
receiving, from the network entity, on a physical downlink shared channel (PDSCH), a medium access control-control element (MAC-CE) activating a subset of TCI states of the list of TCI states, wherein the at least one TCI state is from the activated subset of TCI states.

3. The method of claim 1, wherein the second action delay is associated with a propagation delay, and wherein the network entity is associated with a non-terrestrial network (NTN).

4. The method of claim 1, further comprising:
applying the at least one TCI state at the action time or after the action time.

5. The method of claim 1, further comprising:
transmitting, to the network entity, a UE capability report indicating a UE capability including at least one of: whether the UE supports the second action delay, a supported minimum value of the second action delay, or a supported maximum value of the second action delay.

6. The method of claim 2, wherein the second action delay is configured via at least one of the RRC signaling, the MAC-CE, or the DCI.

7. The method of claim 1, wherein the DCI includes a field that indicates whether to apply the second action delay.

8. The method of claim 1, wherein the action time is further based on at least one of the first action delay or a sum of the first action delay and the second action delay.

9. A method of wireless communication at a network entity, comprising:
transmitting, to a user equipment (UE)-(1-92, a radio resource control (RRC) signaling configuring a list of transmission configuration indicator (TCI) states and a first action delay;
transmitting, to the UE, a downlink control information (DCI) including a DCI based TCI indication indicating at least one TCI state from the list of TCI states;
receiving, from the UE, an acknowledgement (ACK) for the DCI based TCI indication; and
communicating, with the UE, based on an action time associated with the at least one TCI state, wherein the action time is based on at least a second action delay different from the first action delay for the DCI based TCI indication.

10. The method of claim 9, further comprising:
transmitting, to the UE, on a physical downlink shared channel (PDSCH), a medium access control-control element (MAC-CE) activating a subset of TCI states of the list of TCI states, wherein the at least one TCI state is from the activated subset of TCI states.

11. The method of claim 9, further comprising:
receiving, from the UE, a UE capability report indicating a UE capability including at least one of: whether the UE supports the second action delay, a supported minimum value of the second action delay, or a supported maximum value of the second action delay.

12. The method of claim 9, wherein the action time is further based on at least one of the first action delay or a sum of the first action delay and the second action delay.

13. The method of claim 9, further comprising:
transmitting, to the UE, a configuration of the second action delay based on the network entity being associated with an NTN.

14. The method of claim 13, wherein the list of TCI states includes a unified TCI state, the method further comprising:
refraining from transmitting, to the UE, a configuration of the unified TCI state, before the transmitting, to the UE, the configuration of the second action delay.

15. An apparatus for wireless communication comprising:
a transceiver;
a processor; and
a memory coupled to the processor to store instructions, which when executed by the processor, cause the apparatus to:
receive, from a network entity, a radio resource control (RRC) signaling configuring a list of transmission configuration indicator (TCI) states and a first action delay;
receive, from the network entity, a downlink control information (DCI) including a DCI based TCI indication indicating at least one TCI state from the list of TCI states;
transmit, to the network entity, an acknowledgement (ACK) for the DCI based TCI indication; and
communicate, with the network entity, based on an action time associated with the at least one TCI state, wherein the action time is based on at least a second action delay different from the first action delay for the DCI based TCI indication.

16. The apparatus of claim 15, wherein the apparatus is further caused to:
receive, from the network entity, on a physical downlink shared channel (PDSCH), a medium access control-control element (MAC-CE) activating a subset of TCI states of the list of TCI states, wherein the at least one TCI state is from the activated subset of TCI states.

17. The apparatus of claim 15, wherein the second action delay is associated with a propagation delay, and wherein the network entity is associated with a non-terrestrial network (NTN).

18. The apparatus of claim 15, wherein the apparatus is further caused to:
apply the at least one TCI state at the action time or after the action time.

19. The apparatus of claim 15, wherein the apparatus is further caused to:
transmit, to the network entity, a UE capability report indicating a UE capability including at least one of: whether the UE supports the second action delay, a supported minimum value of the second action delay, or a supported maximum value of the second action delay.

20. The apparatus of claim 16, wherein the second action delay is configured via at least one of the RRC signaling, the MAC-CE, or the DCI.
